(19) United States
(12) Patent Application Publication
(10) Pub. No.: US 2010/0107197 A1
(43) Pub. Date: Apr. 29, 2010

(54) Method and System for Updating Media Content Event Listings

(75) Inventors: Robert S. McGowan, La Mesa, CA (US); Keith J. Kelly, Olivenhain, CA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 12/257,634

(22) Filed: Oct. 24, 2008

(51) Int. Cl. G06F 3/00

(52) U.S. Cl. 725/50

(57) ABSTRACT

A system including a provider module configured to generate search keys for events in a list of events for distribution to a plurality of consumer premises equipment, where the events represent media content accessible by one or more of the plurality of consumer premises equipment. The system also includes an update module configured to generate an update message corresponding to a change in the list of events. The update message includes a search key mask defining one or more search keys to which the change relates and an update command configured to instruct the plurality of consumer premises equipment to update the respective distributed list of events.

### BACKGROUND

1. Technical Field

The present disclosure relates to media content event listings for consumer premise equipment.

2. Discussion of the Background

Today consumers can gain access to a variety of live or pre-recorded media transmitted utilizing a variety of techniques. Traditional television broadcasting techniques have been expanded to include digital signal format, transmitted via satellite, cable, telephone and internet connectivity. Traditionally, print versions of television programming guides were a popular manner in which consumers could determine information regarding television broadcasts, such as when a particular show was going to be broadcast in their region, which channel the show was going to be broadcast on, and possibly even a brief description of the content of the show.

More recently, non-interactive versions of such programming guides have been broadcast that slowly scroll through a listing of shows. Additionally, the advent of satellite and cable digital transmission systems has promulgated more sophisticated customer premises equipment (CPE), including receivers commonly known generically as “set-top boxes.” Such equipment typically has the ability to download program schedules offered by the media content provider to which the consumer subscribes. The consumer can interactively scroll through the program listing of available channels to view the current and future schedule of media content events offered by the media content provider.

One problem with the broadcasting of such media content event listings is that the schedule of events may change at any point in time prior to or during the actual event. Additionally, it can be cumbersome and extremely taxing on the distribution system of the service provider to repeatedly make changes to event listings in each of the various broadcast regions affected by the change, for example, by repeatedly recompiling event listings with such changes incorporated therein and then redistributing such event listings to each consumer premise equipment.

Thus, the need exists for a system and method that can easily and efficiently update media content event listings.

### Disclosure

The present disclosure advantageously provides a system including a provider module configured to generate search keys for events in a list of events for distribution to a plurality of consumer premises equipment, where the events represent media content accessible by one or more of the plurality of consumer premises equipment. The system also includes an update module configured to generate an update message corresponding to a change in the list of events. The update message includes a search key mask defining one or more search keys to which the change relates and an update command configured to instruct the plurality of consumer premises equipment to update the respective distributed list of events.

The present disclosure also advantageously provides a method comprising generating search keys for events in a list of events for distribution to a plurality of consumer premises equipment, where the events represent media content accessible by one or more of the plurality of consumer premises equipment, and generating an update message corresponding to a change in the list of events. The update message includes a search key mask defining one or more search keys to which the change relates and an update command configured to instruct the plurality of consumer premises equipment to update the respective distributed list of events.

Additional advantages of the present disclosure will become readily apparent to those skilled in this art from the following detailed description, wherein only the preferred embodiment is shown and described, simply by way of illustration of the best mode contemplated of carrying out the invention. As will be realized, the disclosure is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

A more complete appreciation of the disclosure and many of the attendant advantages thereof will become readily apparent with reference to the following detailed description, particularly when considered in conjunction with the accompanying drawings, wherein like reference numerals refer to similar elements and in which:

FIG. 1 is a schematic diagram of a system for providing consumer premises equipment with media content event listings and updating the event listings, according to an exemplary embodiment;

FIG. 2A is a schematic diagram of an event list/key provider module for the system, according to an exemplary embodiment;

FIG. 2B is a generic representation of a search key for an event listing generated by the event list/key provider for use in the system, according to an exemplary embodiment;

FIG. 3A is a schematic diagram of an event list update module for the system, according to an exemplary embodiment;

FIG. 3B is a generic representation of a search key mask and update command for an event listing generated by the event list update module for use in the system, according to an exemplary embodiment;

FIG. 4 is an illustration of a process for distributing a list of media content events to consumer premises equipment, according to an exemplary embodiment;

FIG. 5 is an illustration of a process for updating the list of media content events of the consumer premises equipment, according to an exemplary embodiment; and

FIG. 6 is a diagram of a computer system that can be used to implement various exemplary embodiments.

### DETAILED DESCRIPTION OF EXEMPLARY EMBODIMENTS

Embodiments of the present disclosure will be described hereinafter with reference to the accompanying drawings. In the following description, the constituent elements having substantially the same function and arrangement are denoted by the same reference numerals, and repetitive descriptions will be made only when necessary.

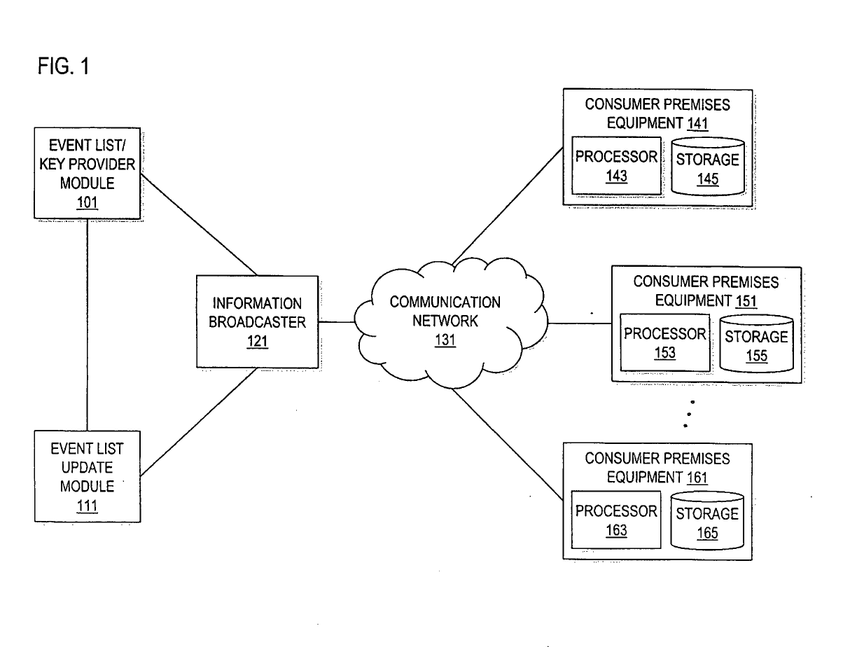

FIG. 1 is a schematic diagram of a system for providing consumer premises equipment with media content event listings and updating the event listings, according to an exemplary embodiment. The system includes an event list/key provider 101, an event list update monitor 111, and an information broadcaster 121 that is connected to a communication network 131 via which the system can communicate with a plurality of consumer premises equipment (CPE) 141, 151, 161, etc. The communication network 131 can be any of a variety of wired or wireless communication systems used to distribute information, and preferably also media content, to the consumer premises equipment of consumers. For example, the communication network could include a traditional broadcasting network, a cable network, a satellite distribution network, telephone line distribution network, internet distribution network, or any combination thereof.

The customer premises equipment (CPE) 141, 151, 161 can include a set-top box, or any device having the processing capabilities thereof, connected to or incorporated as a component of a display device, such as a television or a monitor. The CPE 141, 151, 161 thus each include a processor 143, 153, 163, respectively, and a memory storage device 145, 155, 165, respectively, for storing data, media content, etc. The processor of the CPE contains processing capability for managing program viewing and event listings in response to user commands, and can also have the capability for transmitting and receiving data for media content viewing. Media content, as well as other data can be received by the CPE via a satellite antenna, cable connection, telephone network connection, or any other suitable connection.

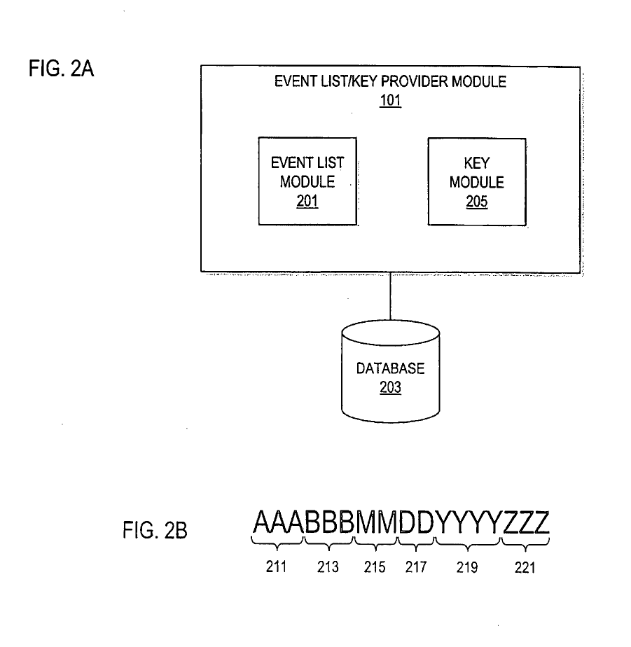

FIG. 2A is a schematic diagram of an event list/key provider module 101 for the system, according to an exemplary embodiment. The event list/key provider module 101 includes an event list module 201, a database 203, and a key module 205.

The event list module 201 can act as a media content event listing provider, such as a television program listing provider. For example, the event listing module 201 can compile a listing of media content scheduled for airing in different regions, and/or in different time zones, and/or for different media content providers for distribution to different content provider customers. The event listing module 201 can compile the listing of media content to include information such as the broadcast time of the media content, the channel the media content will be broadcast on, the title of the media content, a description of the media content, etc. The event listing can be stored in the database 203.

The event listing module 201 can be used to edit the media content event listing at any time. Thus, the event listing can be edited and updated on a real-time basis, and the updated event listing can be stored in the database 203. The entire event listing can be distributed to the CPEs via the communication network 131 using the information broadcaster 121 on an as-needed basis, or at predetermined intervals. Due to the heavy load that the transmission of such an event listing to each of the CPEs would have on available bandwidth of the distribution system of the service provider, the distribution of the entire event listing in this manner should be minimized.

The key module 205 is configured to generate search keys for events in the list of events. FIG. 2B is a generic representation of a search key for an event listing generated by the event list/key provider for use in the system, according to an exemplary embodiment. The key module 205 generates the search keys such that the search key includes a plurality of data fields related to the event to which the search key applies. For example, the data fields can include one or more of an event name data field, an event identifier data field, a date data field, a broadcast region data field, and a time zone data field. The data fields can include one or more data fields that define a subset of the plurality of CPEs that have access to the media content represented by the respective event.

The representative search key show in FIG. 2B can thus be defined as including a data field 211, which is designated using three variables “A,” that defines an event name, a data field 213, which is designated using three variables “B,” that defines an event identifier, a data field 215, which is designated using two variables “M,” that defines a month in which the event is scheduled to be broadcast, a data field 217, which is designated using two variables “D,” that defines a day of the month in which the event is scheduled to be broadcast, a data field 219, which is designated using four variables “Y,” that defines a year in which the event is scheduled to be broadcast, and a data field 221, which is designated using three variables “Z,” that defines a time zone in which the event is scheduled to be broadcast. Thus, one example of such a search key could be “MNF00911082004PST,” which represents a listing for Monday Night Football with an event identifier of “009” representing week 9 that is scheduled to be aired on Nov. 8, 2004 in the Pacific Standard Time zone. The various data fields used and number of variables designated for each data field can be predetermined in a manner such that the data fields can be effectively utilized to provide a unique identifier for each of the events provided in the event listings in each of the various regions/time zones. The search keys are stored with their respective events of the event listing in the database 203.

In an alternative embodiment, the event list module and the key module can be provided on separate platforms that are maintained and operated by different service providers.

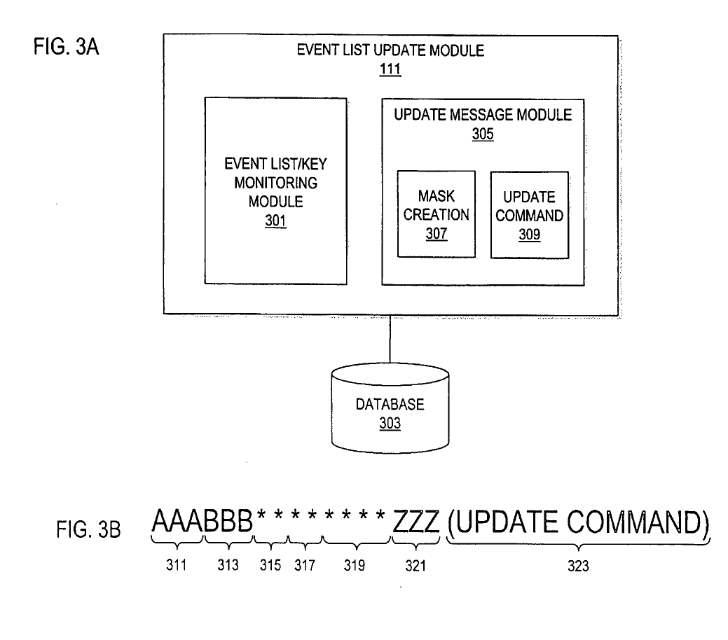

FIG. 3A is a schematic diagram of an event list update module 111 for the system, according to an exemplary embodiment. The event list update module 111 includes an event list/key monitoring module 301, a database 303, and an update message module 305 having a search key mask creation module 307 and an update command module 309.

The event list/key monitoring module 301 can be configured to monitor the current event listings on the event list/key provider module. The event list/key monitoring module 301 can receive or retrieve the current event listings from the database 203 of the event list/key provider module 101. For example, the event list/key monitoring module 301 can receive or retrieve the current event listings from the database 203 at predetermined intervals, or the current event listings can be send by the event list/key provider module 101 automatically at each instance in which the event listing is updated or changed.

The event list/key monitoring module 301 can thus obtain the current event listing and compare the current event listing with the previous version. Based upon this comparison, the event list/key monitoring module can determine whether an update message is needed in order to update the CPEs to reflect the change(s) made to the event listing. If an event listing change is determined, then updated event listing is stored in the database 303 and the update message module 305 is utilized to begin the process of informing the CPEs of the change(s).

As noted above, the update message module 305 is utilized to begin the process of informing the CPEs of change(s) in the event listing. The mask creation module 307 performs the task of creating a search key mask that can be used to identify all of the listings in the various CPEs to which the change applies. Thus, for example, if all of the event listings for week 9 of Monday Night Football will be effected by the changes in the event listings, the mask creation module 307 will create a search key mask such as “MNF009***********.” However, if the change will only effect the event listings for week 9 of Monday Night Football in the Pacific Standard Time zone then the mask creation module 307 will create a search key mask such as “MNF009********PST.” The asterisks (*) in the search key masks represent open data fields or open portions of data fields, thus the search key mask can be used to search for every search key that contains the identified symbols in the indentified data fields in the search key mask, regardless of the information in the open data fields. Thus, the search key mask is configured to match all data fields of the subset of the plurality of CPEs to which the change relates.

For each search key mask created, the update message module 305 then utilizes the update command module 309 to create an update command that can be used to inform the CPEs of change(s) in the event listing. The update command module 309 performs the task of creating the update command for each search key mask that instructs the CPEs on how to modify the event listings that relate to the search key mask. For example, the update command can inform the CPEs that a certain event listing or subset of event listings need to be modified to change the title of the event listing, the description of the event listing, the starting time of the event listing, the running time of the event listing, etc. The update command can be expressed, for example, in abbreviated codes that are recognizable by the CPEs.

Thus, the update message module 305 utilizes the mask creation module 307 and the update command module 309 to formulate an update message that can include one or more sets of search key mask and associated update command. FIG. 3B is a generic representation of a search key mask and update command for an event listing generated by the event list update module 111 for use in the system, according to an exemplary embodiment.

The representative search key mask and associated update command show in FIG. 3B can thus be defined as including a data field 311, which is designated using three closed variables “A,” that defines an event name, a data field 313, which is designated using three closed variables “B,” that defines an event identifier, a data field 315, which is designated using two open variables “*” (these open variables relate to a month in which the event is scheduled to be broadcast), a data field 317, which is designated using two open variables “*” (these open variables relate to a day of the month in which the event is scheduled to be broadcast), a data field 319, which is designated using four open variables “Y” (these open variables relate to a year in which the event is scheduled to be broadcast), a data field 321, which is designated using three closed variables “Z,” that defines a time zone in which the event is scheduled to be broadcast, and a data field 323, which is designated using “UPDATE COMMAND” but can include any number of letters, numbers, or symbols defining an update command. Thus, one example of such a search key mask and update command could be “MNF009********PST (set len 210),” which thereby relates to all listings for Monday Night Football with an event identifier of “009” representing week 9 that is scheduled to be aired in the Pacific Standard Time zone, regardless of the date the event is scheduled to air, and which includes the update command indicating that the length of the event should be set to 210 minutes.

Thus, the update message module 305 formulates an update message that can include one or more sets of search key mask and associated update command, and the event list update module 111 sends the update message to the information broadcaster 121, which transmits the update message to the CPEs (141, 143, 145, etc.) via the communication network 131. Each CPE receives the update message, checks to determine whether any of the search key masks correspond to event listings stored therein, and executes the update command for all relevant search key masks.

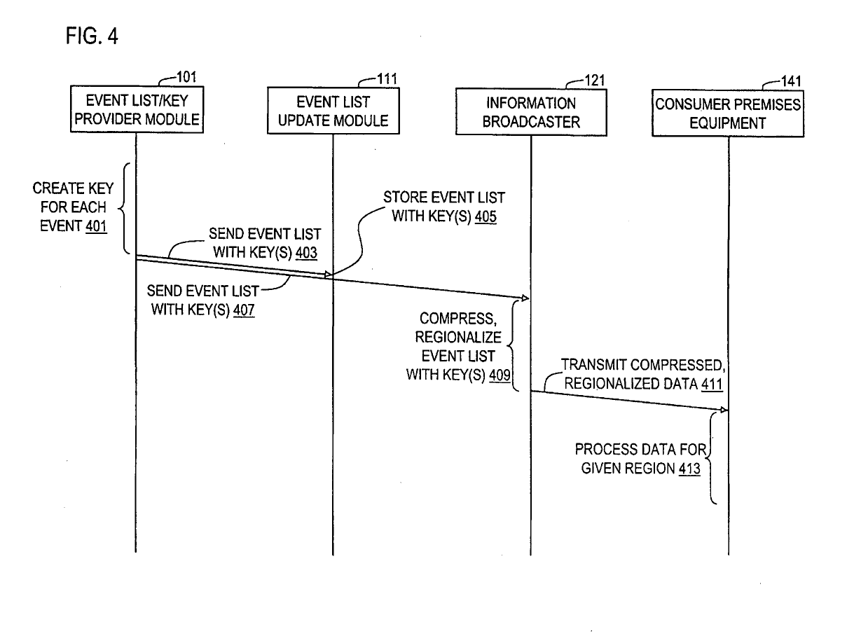

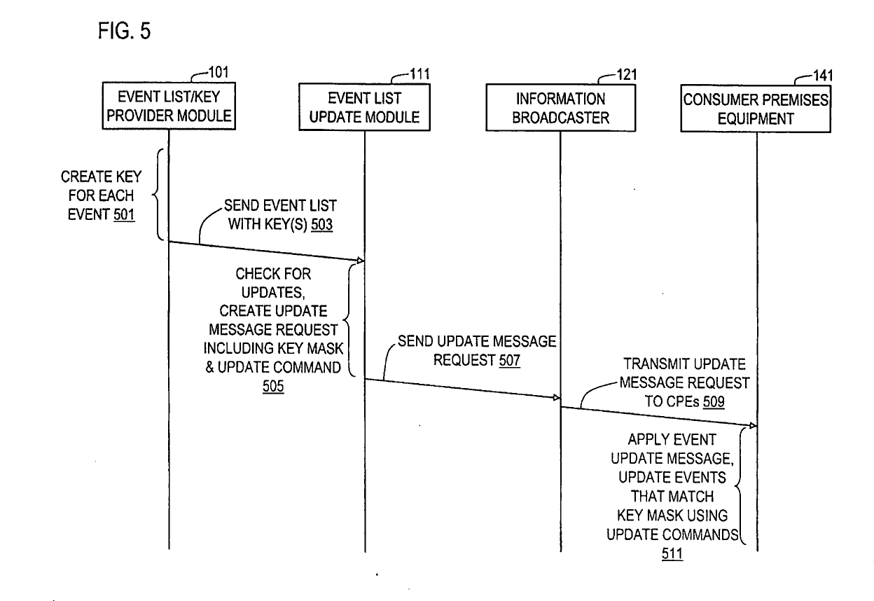

FIG. 4 shows a process for distributing a list of media content events to CPEs, according to an exemplary embodiment. In step 401, the event list/key provider module 101 creates a key for each event in the list of events. In step 403, the event list/key provider module 101 sends the event list with key(s) to the event list update module 111, and the event list update module 111 stores the event list with key(s) in database 303. FIG. 5 illustrates a scenario in which the database 303 already contains a stored event list with key(s), and thus a comparison between the new list and the old list is performed in order to formulate an update message, as will be described below; however, in the scenario in FIG. 4 the event list/key provider module 101 is also sending the event list with key(s) to the information broadcaster 121 in step 407 for transmission to the CPEs and thus no update message is necessary.

In step 409, the information broadcaster 121 compresses and regionalizes the event list with key(s), and transmits the compressed, regionalized data to the CPEs, such as CPE 141 in step 411. In step 413, the CPEs, such as CPE 141, each receive the compressed, regionalized data and process the data for the given relevant region of that particular CPE. The CPEs can then utilize this data to provide the customers with scrolling or interactive media content program listings (e.g., so called “television guides”).

FIG. 5 illustrates a process for updating the list of media content events of the CPEs, according to an exemplary embodiment. Thus, the scenario shown in FIG. 5 relates to a situation in which the event list update module 111 and the CPEs have already received and stored an event list with key(s), and an update is being performed on the event list.

In step 501, the event list/key provider module 101 creates a key for each event in the list of events. Thus, the event list/key provider module 101 is performing in the same manner as in FIG. 4 in this regard. In step 403, the event list/key provider module 101 sends the event list with key(s) to the event list update module 111, but does not send the event list with key(s) to the information broadcaster 121. The event list update module 111 receives the event list with key(s) and compares the new event list to an old event list stored in database 303 in order to check for updates in step 505. If the event list/key monitoring module 301 of the event list update module 111 determines that an update is required (e.g., if one or more portions of the old event list have been updated as represented by the new event list), then an update message is created that acts as a request by the event list update module 111 to one or more CPEs to update the event list stored therein. Thus, the mask creation module 307 creates an appropriate search key mask (see discussion above) and the update command module 309 creates an appropriate update command (see discussion above), and an update message requesting such an update is sent from the event list update module 111 to the information broadcaster 121 in step 507.

In step 509, the information broadcaster 121 transmits the update message requesting the updating of the event listing to the CPEs, such as CPE 141. In step 511, the CPEs, such as CPE 141, each receives the update message and applies the event message update. Thus, the CPEs each determine if any of the search mask keys contained in the update message match any of the search keys stored therein, and update the event listing for each matching search key using the corresponding update command. Thus, rather than distributing the entire event list to all of the CPEs each time an event listing is updated, the system sends a relatively small update message that is directs the updating of only the relevant event listings.

Thus, the system provides the concept of an “event search key” (ESK) and an “event update message” (EUM). The system associates each event in, for example, a television listings data with an ESK, and the system can make changes to an event listing, or set of event listings, by sending a EUM that references the ESK. The CPE, such as a set-top box, will then update the listings for every program that matches the ESK. The ESK allows the EUM to update many events in multiple regions.

The ESK is a set of characters. Each system can assign the characters in a way that suits that system. The set-top box compares each television listing's ESK characters to a mask sent in the EUM. If the there is a match, then the set-top box updates the associated event listing.

The system provides a streamlined manner in which to update the event listing provided to consumers via CPEs. The system provides such updates without overburdening the distribution network, as would be the case if updated versions of the entire event listing were repeatedly sent to consumers.

The processes described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

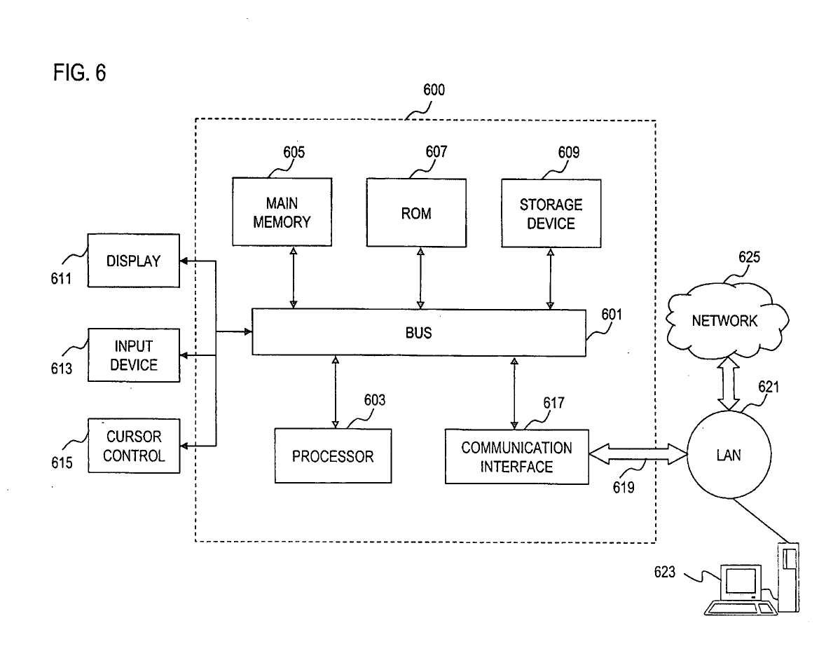

FIG. 6 illustrates computing hardware (e.g., computer system) 600 upon which an embodiment according to the disclosure can be implemented. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the disclosure, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the disclosure. Thus, embodiments of the disclosure are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the disclosure through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the disclosure may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the disclosure has been described in connection with a number of embodiments and implementations, the disclosure is not so limited but covers various obvious modifications and equivalent arrangements.

What is claimed is:

1. A system comprising:
a provider module configured to generate search keys for events in a list of events for distribution to a plurality of consumer premises equipment, the events representing media content; and
an update module configured to generate an update message corresponding to a change in the list of events, the update message including a search key mask defining one or more search keys to which the change relates and an update command for updating the list of events.

2. The system according to claim 1, further comprising:
an information broadcaster configured to distribute the list of events and search keys generated by the provider module, and configured to distribute an updated message generated by the updated module, to the plurality of consumer premises equipment.

3. The system according to claim 1, further comprising:
said plurality of consumer premises equipment,
wherein each one of said plurality of consumer premises equipment is configured to receive the list of events and search keys, to determine events in the list of events that correspond to that respective one consumer premises equipment, and to store the corresponding events with respective search keys in that respective one consumer premises equipment.

4. The system according to claim 3, further comprising:
an information broadcaster configured to distribute the list of events and search keys to said plurality of consumer premises equipment,
wherein said provider module is configured to send an updated list of events and search keys to said update module; and
wherein said information broadcaster is configured to distribute the update message to said plurality of consumer premises equipment.

5. The system according to claim 4, wherein said information broadcaster is configured to distribute a list of events and search keys to said plurality of consumer premises equipment at predetermined first intervals, and said information broadcaster is configured to send an update message to said plurality of consumer premises equipment at intervals shorter than the first interval.

6. The system according to claim 4, wherein said one consumer premises equipment is configured to receive an update message, to determine search keys in the stored list of events with respective search keys of that respective consumer premises equipment to which the change relates, and to update the stored list of events with respective search keys based on the update command.

7. The system according to claim 1, wherein the search key includes a plurality of data fields related to a respective event.

8. The system according to claim 7, wherein the plurality of data fields includes one or more of an event name data field, an event identifier data field, a date data field, a broadcast region data field, and a time zone data field.

9. The system according to claim 7, wherein one or more of the plurality of data fields define a subset of the plurality of consumer premises equipment that have access to the media content represented by the respective event.

10. The system according to claim 9, wherein the search key mask is configured to match all data fields of the subset of the plurality of consumer premises equipment to which the change relates.

11. A method comprising:
generating search keys corresponding to events in a list of media content accessible by one or more of a plurality of consumer premises equipment;
generating a search key mask defining one or more search keys corresponding to a change in the list of events; and
communicating an update message to the plurality of consumer premises equipment, the update message comprising the search key mask and an update command

12. The method according to claim 11, further comprising:
distributing the list of events and search keys to the plurality of consumer premises equipment.

13. The method according to claim 12, further comprising determining events in the list of events that correspond to a respective one of the plurality of consumer premises equipment, and storing the corresponding events with respective search keys in the one consumer premises equipment.

14. The method according to claim 13, further comprising:
generating the update message from an updated list of events and search keys.

15. The method according to claim 14, wherein a list of events and search keys is distributed to the plurality of consumer premises equipment at predetermined first intervals, and an update message is broadcast to the plurality of consumer premises equipment at intervals that is shorter than the first interval.

16. The method according to claim 14, further comprising updating the stored list of events with respective search keys in response to the update command.

17. The method according to claim 11, wherein the search key includes a plurality of data fields related to the respective event.

18. The method according to claim 17, wherein the plurality of data fields includes one or more of an event name data field, an event identifier data field, a date data field, a broadcast region data field, and a time zone data field.

19. The method according to claim 17, wherein one or more of the plurality of data fields define a subset of the plurality of consumer premises equipment that have access to the media content represented by the respective event.

20. The method according to claim 19, wherein the search key mask is configured to match all data fields of the subset of the plurality of consumer premises equipment to which the change relates.
